(19) United States
(12) Patent Application Publication
(10) Pub. No.: US 2022/0224616 A1
(43) Pub. Date: Jul. 14, 2022

(54) End-to-End Network Performance Measurement, Diagnosis, and Tuning

(71) Applicant: CenturyLink Intellectual Property LLC, Broomfield, CO (US)

(72) Inventors: Carl Andress, Apple Valley, MN (US); Sam Plankis, Franklin, NC (US)

(21) Appl. No.: 17/367,143

(22) Filed: Jul. 2, 2021

Related U.S. Application Data
(60) Provisional application No. 63/135,899, filed on Jan. 11, 2021.

(51) Int. Cl. H04L 12/26

(52) U.S. Cl. CPC H04L 43/08

(57) ABSTRACT

Novel tools and techniques are provided for implementing end-to-end network performance measurement, diagnosis, and tuning. In various embodiments, a network diagnosis device may send a message to a computing system over a network, the message indicating that the network diagnosis device is communicatively coupled to a customer premises equipment (“CPE”) at a customer premises associated with a user and that it is ready to begin diagnosis. In response to receiving the message from the network diagnosis device, the computing system may initiate a network performance test of a network path between the network diagnosis device at the customer premises and a testing server in the network, via any intermediate nodes. The computing system may analyze the network performance data to identify any issues with the network service provided to the CPE and to isolate a source of any identified issues, and may send the results.

### CROSS-REFERENCES TO RELATED APPLICATIONS

This application claims priority to U.S. Patent Application Ser. No. 63/135,899 (the “'899 Application”), filed Jan. 11, 2021 by Carl Andress et al. (attorney docket no. 1606-US-P1), entitled, “End-to-End Network Performance Measurement, Diagnosis, and Tuning,” the disclosure of which is incorporated herein by reference in its entirety for all purposes.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network performance measurement, and, more particularly, to methods, systems, and apparatuses for implementing end-to-end network performance measurement, diagnosis, and tuning.

### BACKGROUND

Within Service Assurance, customer throughput issues are one of the most challenging and tedious types of problems encountered. Advanced technical skills are required to conduct and analyze testing using conventional diagnosis programs (e.g., iPerf, or the like), which currently requires a truck roll or a technical customer. While an extremely useful program if used correctly, programs such as iPerf can be easily influenced from the customer environment by being installed on an under-performing laptop computer, a complex local area network (“LAN”) environment, or simple misuse, and the like, all of which can contribute to incorrect test results. Although other similar conventional tools exist (e.g., perfSONAR, or the like), such conventional tools are software-only solutions that only provides packet loss information from a ping and not from iPerf-like test itself. Such conventional tools also do not provide cellular (e.g., 4G) connectivity, do not measure out-of-order packets, and do not measure for packet header modification from a firewall.

Hence, there is a need for more robust and scalable solutions for implementing network performance measurement, and, more particularly, to methods, systems, and apparatuses for implementing end-to-end network performance measurement, diagnosis, and tuning.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing end-to-end network performance measurement, diagnosis, and tuning, in accordance with various embodiments.

FIG. 2 is a schematic diagram illustrating various non-limiting examples of transmission of messages and test packets during implementation of end-to-end network performance measurement, diagnosis, and tuning, in accordance with various embodiments.

FIGS. 3A-3G are schematic diagrams illustrating a non-limiting example of comparison of captured test packets with test packets that are sent to determine whether at least one of packet loss, out-of-order packets, improper device configuration, reduced packet transmission speed, or firewall interference has occurred during implementation of end-to-end network performance measurement, diagnosis, and tuning, in accordance with various embodiments.

FIGS. 4A-4I are flow diagrams illustrating a method for implementing end-to-end network performance measurement, diagnosis, and tuning, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

Overview

Various embodiments provide tools and techniques for implementing network performance measurement, and, more particularly, to methods, systems, and apparatuses for implementing end-to-end network performance measurement, diagnosis, and tuning.

In various embodiments, a service provider may send a network diagnosis device to a user at a customer premises for the user to plug into a CPE. In response to the network diagnosis device being powered on and being communicatively coupled to the CPE at the customer premises associated with the user, the network diagnosis device may send a message to a computing system over a network, the message indicating that the network diagnosis device is communicatively coupled to the CPE and that it is ready to begin diagnosis. The network diagnosis device is configured to communicate with the computing system via a cellular communications channel via cellular communications network(s) (including at least one of 3G, 4G, 4G LTE, or 5G network(s), or the like) and is further configured to communicate with the computing system over the service provider network(s) via the CPE and via one of a SSH tunnel or a reverse SSH tunnel over a network path that connects a plurality of devices including the network diagnosis device, the CPE, a testing server, and any intermediate network nodes.

In response to receiving the message from the network diagnosis device, the computing system may initiate a network performance test of the network path between the network diagnosis device at the customer premises and the testing server in the service provider network(s). The network performance test may comprise sending one or more test packets from one of the network diagnosis device or the testing server to the other of the network diagnosis device or the testing server along the network path, and the other of the network diagnosis device or the testing server capturing the one or more test packets.

The computing system may analyze network performance data collected from the network performance test to identify any issues with network service provided to the CPE assigned to the user and to isolate a source of any identified issues with the network service provided to the CPE, by analyzing the captured one or more test packets (a copy of which may be sent to the computing system via the cellular communications network(s), or alternatively via a different network path through the service provider network(s)) to determine whether at least one of packet loss, out-of-order packets, improper device configuration, reduced packet transmission speed, or firewall interference has occurred.

The computing system may send results of the network performance test and information pertaining to any identified issues with the network service based on the analysis. The information pertaining to any identified issues with the network service may comprise at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

According to some embodiments, the network diagnosis device may comprise at least one of a Raspberry Pi-based network diagnosis device, a network interface controller (“NIC”), or a high-performance computing device. In some instances, the computing system may comprise at least one of a server computer, the testing server, a cloud-based computing system, or a distributed computing system, and/or the like.

In some aspects, the network diagnosis device (which, in some cases, may include a program or device referred to herein as “PiPerf,” or the like) may be configured to automate iPerf-type testing and analysis with communication to/from the device with a wireless connection (e.g., 3G, 4G, 4G LTE, or 5G, etc.). In this manner, the service provider can ship the network diagnosis device directly to the customer. Once the customer plugs the device in and powers it on, Service Assurance technicians can navigate through a user-friendly menu to complete the iPerf-type testing. In some cases, the device may be plugged directly into the customer's CPE (e.g., router, or the like) to bypass any complex LAN environment, the customer's under-performing user device (e.g., laptop, desktop, etc.), or other outside influences, and/or the like, thus ensuring a quick and accurate result.

Further, field technicians in Enterprise Repair may be empowered to troubleshoot and resolve customer throughput issues quickly, accurately, and much more efficiently, and without the need to go through extensive training with the PiPerf interface or use. This will improve the customer's experience for this type of issue and will also positively impact field technicians by reducing the number of truck rolls.

These and other aspects of the end-to-end network performance measurement, diagnosis, and tuning are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, network performance monitoring technology, network performance measurement, diagnosis, and tuning technology, and/or the like. In other aspects, certain embodiments, can improve the functioning of user equipment or systems themselves (e.g., network performance monitoring systems, network performance measurement, diagnosis, and tuning systems, etc.), for example, by in response to being powered on and being communicatively coupled to a customer premises equipment (“CPE”) at a customer premises associated with a user, sending, using a network diagnosis device, a message to a computing system over a network, the message indicating that the network diagnosis device is communicatively coupled to the CPE and that it is ready to begin diagnosis, wherein the network diagnosis device is a plug-and-play device that is configured to communicate with the computing system via a cellular communications channel and that is further configured to communicate with the computing system over the network via the CPE and via one of a secure shell (“SSH”) tunnel or a reverse SSH tunnel; in response to receiving the message from the network diagnosis device, initiating, using the computing system, a network performance test of a network path between the network diagnosis device at the customer premises and a testing server in the network, the network path further including the CPE and one or more intermediate network nodes between the CPE and the testing server, wherein the network performance test comprises sending one or more test packets from one of the network diagnosis device or the testing server to the other of the network diagnosis device or the testing server along the network path and capturing, using the other of the network diagnosis device or the testing server, the one or more test packets; analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of packet loss, out-of-order packets, improper device configuration, reduced packet transmission speed, or firewall interference has occurred; and sending, using the computing system, results of the network performance test and information pertaining to any identified issues with the network service based on the analysis, wherein the information pertaining to any identified issues with the network service comprises at least one of information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

In particular, to the extent any abstract concepts are present in the various embodiments, those concepts can be implemented as described herein by devices, software, systems, and methods that involve specific novel functionality (e.g., steps or operations), such as, a network diagnosis device sending a message to a computing system over a network (i.e., a cellular communications network(s) if such connection is determined to be stable or through the service provider network(s)), the message indicating that the network diagnosis device is communicatively coupled to a customer premises equipment (“CPE”) at a customer premises associated with a user and that it is ready to begin diagnosis; the computing system initiating a network performance test of a network path via the service provider network between the network diagnosis device at the customer premises and a testing server in the service provider network, in response to receiving the message from the network diagnosis device; the computing system analyzing network performance data collected from the network performance test to identify any issues with network service provided to the CPE assigned to the user and to isolate a source of any identified issues with the network service provided to the CPE, by analyzing the captured one or more test packets to determine whether at least one of packet loss, out-of-order packets, improper device configuration, reduced packet transmission speed, or firewall interference has occurred; and the computing system sending results of the network performance test and information pertaining to any identified issues with the network service based on the analysis; and/or the like, which optimizes end-to-end network performance measurement, diagnosis, and tuning, and/or the like, to name a few examples, that extend beyond mere conventional computer processing operations. These functionalities can produce tangible results outside of the implementing computer system, including, merely by way of example, quick, accurate, and much more efficient troubleshooting and resolution of customer network throughput issues via the optimized end-to-end network performance measurement, diagnosis, and tuning, and/or the like, at least some of which may be observed or measured by customers and/or service providers.

In an aspect, a method may comprise, in response to being powered on and being communicatively coupled to a customer premises equipment (“CPE”) at a customer premises associated with a user, sending, using a network diagnosis device, a message to a computing system over a network, the message indicating that the network diagnosis device is communicatively coupled to the CPE and that it is ready to begin diagnosis, wherein the network diagnosis device may be a plug-and-play device that is configured to communicate with the computing system via a cellular communications channel and that is further configured to communicate with the computing system over the network via the CPE and via one of a secure shell (“SSH”) tunnel or a reverse SSH tunnel. The method may further comprise, in response to receiving the message from the network diagnosis device, initiating, using the computing system, a network performance test of a network path between the network diagnosis device at the customer premises and a testing server in the network, the network path further including the CPE and one or more intermediate network nodes between the CPE and the testing server, wherein the network performance test may comprise sending one or more test packets from one of the network diagnosis device or the testing server to the other of the network diagnosis device or the testing server along the network path and capturing, using the other of the network diagnosis device or the testing server, the one or more test packets.

The method may also comprise analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of packet loss, out-of-order packets, improper device configuration, reduced packet transmission speed, or firewall interference has occurred. The method may further comprise sending, using the computing system, results of the network performance test and information pertaining to any identified issues with the network service based on the analysis, wherein the information pertaining to any identified issues with the network service may comprise at least one of information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

In another aspect, a method may comprise sending, using a network diagnosis device, a message to a computing system over a network, the message indicating that the network diagnosis device is communicatively coupled to a customer premises equipment (“CPE”) at a customer premises associated with a user and that it is ready to begin diagnosis; in response to receiving the message from the network diagnosis device, initiating, using the computing system, a network performance test of a network path between the network diagnosis device at the customer premises and a testing server in the network, the network path further including the CPE and one or more intermediate network nodes between the CPE and the testing server; analyzing, using the computing system, network performance data collected from the network performance test to identify any performance issues with network service provided to the CPE assigned to the user; and sending, using the computing system, results of the network performance test and information pertaining to any identified performance issues with the network service provided to the CPE based on the analysis.

In some embodiments, the network diagnosis device may be a plug-and-play device that is configured to communicate with the computing system via a cellular communications channel and that is further configured to communicate with the computing system over the network via the CPE. In some cases, the cellular communications channel may comprise at least one of a third generation (“3G”) broadband cellular network communications channel, a fourth generation (“4G”) broadband cellular network communications channel, a 4G long term evolution (“LTE”) broadband cellular network communications channel, or a fifth generation (“5G”) broadband cellular network communications channel, and/or the like. In some instances, the network diagnosis device may be configured to communicate with the computing system over the network via the CPE, using one of a secure shell (“SSH”) tunnel or a reverse SSH tunnel.

According to some embodiments, the network diagnosis device may comprise at least one of a Raspberry Pi-based network diagnosis device, a network interface controller (“NIC”), or a high-performance computing device, and/or the like. In some cases, the computing system may comprise at least one of a server computer, the testing server, a cloud-based computing system, or a distributed computing system, and/or the like.

In some instances, sending, using the network diagnosis device, the message to the computing system over the network may comprise sending, using the network diagnosis device, the message to the computing system over the network, in response to the network diagnosis device being powered on and being communicatively coupled to the CPE at the customer premises associated with the user.

In some embodiments, initiating the network performance test may comprise: sending one or more test packets from a first device among a plurality of devices along the network path through a second device among the plurality of devices along the network path, wherein the plurality of devices comprises the network diagnosis device, the CPE, the testing server, and each of the one or more intermediate network nodes; and capturing, using the second device, the one or more test packets. In some cases, sending the one or more test packets from the first device to the second device along the network path may comprise at least one of: sending one or more test packets from one of the network diagnosis device or the testing server to the other of the network diagnosis device or the testing server along the network path; sending one or more test packets from one of the network diagnosis device or the CPE to the other of the network diagnosis device or the CPE along the network path; sending one or more test packets from one of the CPE or a first intermediate network node among the one or more intermediate network nodes to the other of the CPE or the first intermediate network node along the network path; sending one or more test packets from one of a second intermediate network node among the one or more intermediate network nodes or a third intermediate network node among the one or more intermediate network nodes to the other of the second intermediate network node or the third intermediate network node along the network path; or sending one or more test packets from one of a fourth intermediate network node among the one or more intermediate network nodes or the testing server to the other of the fourth intermediate network node or the testing server along the network path.

According to some embodiments, analyzing, using the computing system, the network performance data collected from the network performance test may comprise analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of one or more network performance issues has occurred. In some cases, the one or more network performance issues may comprise one or more of packet loss, out-of-order packets, improper device configuration, reduced packet transmission speed, reduced throughput, or firewall interference, and/or the like. In some instances, the information pertaining to any identified issues with the network service may comprise at least one of: information regarding whether at least one of packet loss, out-of-order packets, improper device configuration, reduced packet transmission speed, reduced throughput, or firewall interference, and/or the like, has occurred; information regarding a potential source or location of the identified issues; or information regarding potential solutions for addressing the identified issues; and/or the like.

Merely by way of example, in some cases, identifying any performance issues may comprise determining that packet loss has occurred, wherein determining that packet loss has occurred may comprise: counting the one or more test packets that are sent to determine a first number of packets; counting the captured one or more test packets to determine a second number of packets; and comparing the first number of packets with the second number of packets to determine whether the second number of packets is less than the first number of packets.

Alternatively, or additionally, identifying any performance issues may comprise determining that out-of-order packets has occurred, wherein determining that out-of-order packets has occurred may comprise: determining a first order in which the one or more test packets are sent; determining a second order in which the captured one or more test packets are received; and comparing the first order with the second order to determine whether the second order is different from the first order.

Alternatively, or additionally, identifying any performance issues may comprise determining that improper device configuration has occurred, wherein determining that improper device configuration has occurred may comprise: comparing the captured one or more test packets with the one or more test packets that are sent to determine whether any of the plurality of devices along the network path has a network configuration or a device configuration that is not optimal for transmission of the one or more test packets compared with expected optimal packet transmission characteristics.

Alternatively, or additionally, identifying any performance issues may comprise determining that reduced packet transmission speed has occurred, wherein determining that reduced packet transmission speed has occurred may comprise: determining a first time at which the one or more test packets are sent; determining a second time at which the captured one or more test packets are received; counting the captured one or more test packets to determine a third number of packets; calculating a first average packet transmission speed based on the third number of packets and a difference between the second time and the first time; and comparing the first average packet transmission speed with an expected packet transmission speed to determine whether the first average packet transmission speed is less than the expected packet transmission speed by a first predetermined threshold amount.

Alternatively, or additionally, identifying any performance issues may comprise determining that reduced throughput has occurred, wherein determining that reduced throughput has occurred may comprise: determining a first processing rate at which the one or more test packets that are sent are processed by the first device; determining a second processing rate at which the captured one or more test packets are processed by the second device; and comparing the first processing rate with the second processing rate to determine whether the second processing rate is different from the first processing rate by a second predetermined threshold amount.

Alternatively, or additionally, identifying any performance issues may comprise determining that firewall interference has occurred, wherein determining that firewall interference has occurred may comprise: counting header bytes of the one or more test packets that are sent to determine a first number of header bytes; counting header bytes of the captured one or more test packets to determine a second number of header bytes; and comparing the first number of header bytes with the second number of header bytes to determine whether the second number of header bytes is less than the first number of header bytes.

In yet another aspect, a system might comprise a network diagnosis device and a computing system. The network diagnosis device might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the network diagnosis device to: send a message to a computing system over a network, the message indicating that the network diagnosis device is communicatively coupled to a customer premises equipment (“CPE”) at a customer premises associated with a user and that it is ready to begin diagnosis.

The computing system might comprise at least one second processor and a second non-transitory computer readable medium communicatively coupled to the at least one second processor. The second non-transitory computer readable medium might have stored thereon computer software comprising a second set of instructions that, when executed by the at least one second processor, causes the computing system to: in response to receiving the message from the network diagnosis device, initiate a network performance test of a network path between the network diagnosis device at the customer premises and a testing server in the network, the network path further including the CPE and one or more intermediate network nodes between the CPE and the testing server; analyze network performance data collected from the network performance test to identify any performance issues with network service provided to the CPE assigned to the user; and send results of the network performance test and information pertaining to any identified performance issues with the network service provided to the CPE based on the analysis.

Various modifications and additions can be made to the embodiments discussed without departing from the scope of the invention. For example, while the embodiments described above refer to particular features, the scope of this invention also includes embodiments having different combination of features and embodiments that do not include all of the above described features.

Specific Exemplary Embodiments

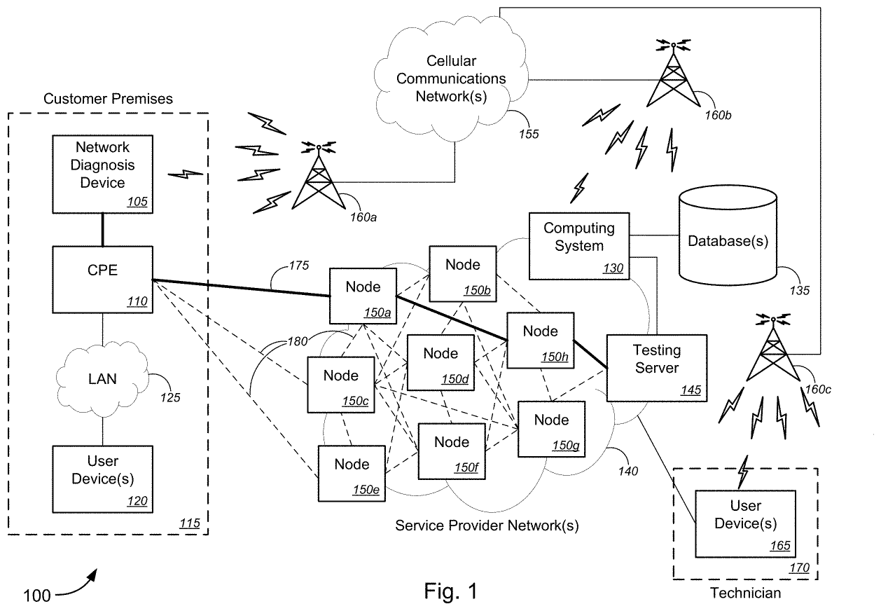

We now turn to the embodiments as illustrated by the drawings. FIGS. 1-6 illustrate some of the features of the method, system, and apparatus for implementing network performance measurement, and, more particularly, to methods, systems, and apparatuses for implementing end-to-end network performance measurement, diagnosis, and tuning, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing end-to-end network performance measurement, diagnosis, and tuning, in accordance with various embodiments.

In the non-limiting embodiment of FIG. 1, system 100 may comprise a network diagnosis device 105, which may include, without limitation, at least one of a Raspberry Pi-based network diagnosis device, a network interface controller (“NIC”), or a high-performance computing device, and/or the like. System 100 may further comprise a customer premises equipment (“CPE”) 110 at a customer premises 115 associated with a user or customer of a service provider. In some instances, CPE 110 may include, but is not limited to, a residential gateway (“RG”), a business gateway (“BG”), a set-top box, a network switch(es), a router(s), a modem(s), a home networking adapter(s), or other network gateway, and/or the like. In some cases, customer premises 115 may include, but is not limited to, one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some instances, CPE 110 may communicatively couple with one or more user devices 120 within customer premises 115 via local area network (“LAN”) 125. In some embodiments, user devices 120 may include, without limitation, at least one of one or more smart phones, one or more mobile phones, one or more tablet computers, one or more laptop computers, one or more desktop computers, one or more televisions, one or more monitors, one or more projectors, one or more media players, one or more speakers, one or more microphones, one or more digital home assistants, one or more office equipment (e.g., printers, scanners, etc.), one or more kitchen appliances (e.g., refrigerator, microwave, oven, dish washer, toasters, pressure cookers, etc.), one or more home appliances (e.g., washer, dryer, home security system, automatic window opening/closing systems, automatic door opening/closing systems, etc.), and/or the like.

System 100 may further comprise a computing system 130 and corresponding database(s) 135 that are disposed or located within service provider network(s) 140. System 100 may further comprise a testing server 145 and one or more network nodes or nodes 150a-15h (collectively, “nodes 150” or the like), all disposed or located within service provider network(s) 140. In some embodiments, computing system 130, database(s) 135, and testing server 145 may be embodied as a single device. Alternatively, computing system 130, database(s) 135, and testing server 145 may be embodied as separate devices. System 100 may further comprise cellular communications network(s) 155 that are separate from the service provider network(s) 140. One or more telecommunications relay systems 160a-160c (collectively, “telecommunications relay systems 160” or the like) may be used to route wireless signals (denoted by lightning bolt symbols in FIG. 1, or the like) through the cellular communications network(s) 160 to and/or from a plurality of devices. In some cases, the computing system 130 and/or the testing server 145 may communicatively couple with one or more user devices 165 associated with a technician 170 (who may be an employee or a contractor (or sub-contractor) of the service provider) either via service provider network(s) 140 or via cellular communications network(s) 155 (and the telecommunications relay systems 160 that are closest to each communicating device; in this non-limiting example, telecommunications relay systems 160b and 160c, respectively).

In some instances, the computing system 130 may include, without limitation, at least one of a server computer, the testing server 145, a cloud-based computing system, or a distributed computing system, and/or the like. In some cases, the one or more user devices 165 may include, but is not limited to, one or more of at least one smart phone, at least one mobile phone, at least one tablet computer, at least one laptop computer, or at least one portable testing interface device, and/or the like.

According to some embodiments, network(s) 140 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 140 may include an access network of the service provider (e.g., an Internet service provider (“ISP”)). In another embodiment, the network(s) 140 may include a core network of the service provider and/or the Internet. The cellular communications network(s) 155 can include, but is not limited to, a third generation (“3G”) broadband cellular network, a fourth generation (“4G”) broadband cellular network, a 4G long term evolution (“LTE”) broadband cellular network, or a fifth generation (“5G”) broadband cellular network, and/or the like.

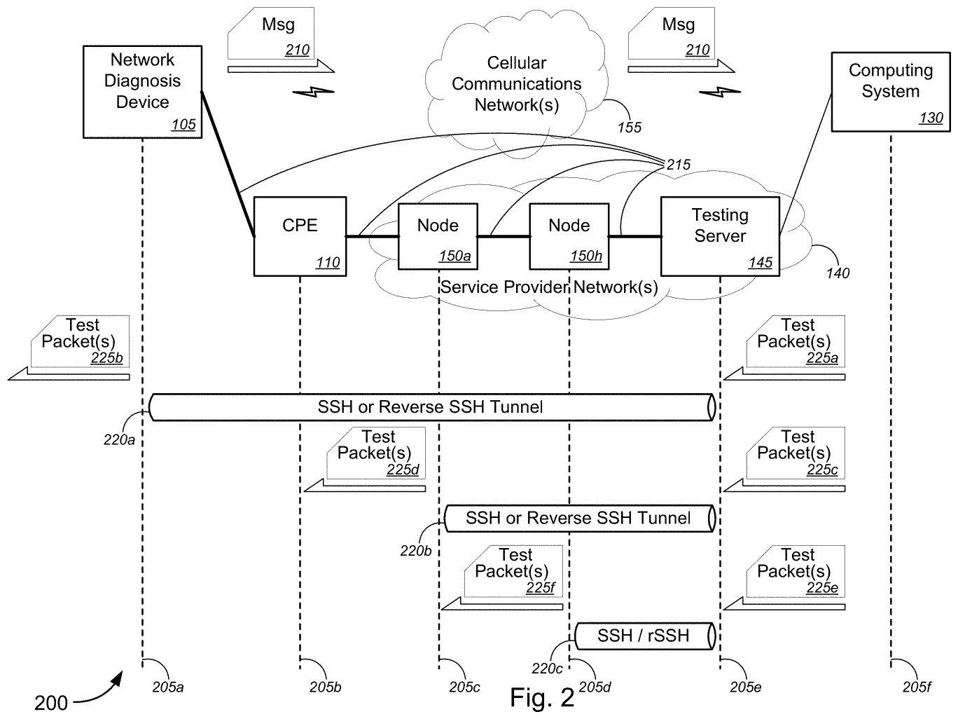

In some embodiments, the network diagnosis device 105 may be a plug-and-play device that is configured to communicate with the computing system 130 via a cellular communications channel over network(s) 155 and that is further configured to communicate with the computing system 130 over the network(s) 140 via the CPE 110. In some cases, the cellular communications channel may include, without limitation, at least one of a third generation (“3G”) broadband cellular network communications channel, a fourth generation (“4G”) broadband cellular network communications channel, a 4G long term evolution (“LTE”) broadband cellular network communications channel, or a fifth generation (“5G”) broadband cellular network communications channel, and/or the like. In some instances, the network diagnosis device 105 may be configured to communicate with the computing system 130 over the network(s) 140 via the CPE 110, using one of a secure shell (“SSH”) tunnel or a reverse SSH tunnel (as shown in FIG. 2). Herein, a SSH tunnel may refer to a secure channel over a network (typically, over an unsecure network) that is established when a SSH connection is initiated from a local computer to a remote computer, while a reverse SSH tunnel may refer to a similar secure channel over a network (typically, over an unsecure network) that is established when a SSH connection is initiated from the remote computer to the local computer. In some cases, a reverse SSH tunnel may be used if the remote computer is difficult to reach (e.g., due to tight firewall rules, complex network address translation rules, and/or the like).

In some instances, CPE 110 may be either (a) owned and controlled by a service provider that merely provides the CPE to the user (with associated monthly fees) with condition of return of the CPE at end of service (or penalty for failure to return) or (b) a user-purchased CPE that is compatible with the service provided by the service provider and that is purchased either (i) from the service provider or (ii) from a third party provider/retailer. Quite differently, the network diagnosis device 105 is owned and controlled by the service provider. By controlling the network diagnosis device 105 as well as all the nodes 150 in the network(s) 140 and the testing server 145, the service provider is able to control a majority (if not all) variables with respect to end-to-end network performance measurement, diagnosis, and tuning. Particularly, by controlling the end points of a network path (namely, the testing server 145 and the network diagnosis device 105), device and network configurations may be optimized beforehand (i.e., before a network performance test has been initiated) and other variables may be controlled or eliminated, so as to isolate any potential issues with network performance that may be detected or determined based on the network performance test.

In operation, the service provider may send the network diagnosis device 105 to the user at the customer premises 115 for the user to plug into the CPE 110. In response to the network diagnosis device 105 being powered on and being communicatively coupled to CPE 110 at customer premises 115 associated with the user, network diagnosis device 105 may send a message to computing system 130 over a network, the message indicating that the network diagnosis device is communicatively coupled to the CPE and that it is ready to begin diagnosis. The network diagnosis device 105 is configured to communicate with the computing system 130 via a cellular communications channel via cellular communications network(s) 155 (including at least one of 3G, 4G, 4G LTE, or 5G network(s), or the like) and via telecommunications relay systems 160a and 160b and is further configured to communicate with the computing system 130 over the service provider network(s) 140 via the CPE 110 and via one of a SSH tunnel or a reverse SSH tunnel over a network path that connects a plurality of devices including the network diagnosis device 105, the CPE 110, Node 150a, Node 150h, and testing server 145 (which is communicatively coupled to computing system 130), as depicted by thick solid line 175 in FIG. 1. Although FIG. 1 depicts this particular network path 175, the various embodiments are not so limited and any combination of connections from/to CPE 110 to testing server 145 via nodes 150 along selected or determined communications links denoted by dashed lines 180 in FIG. 1.

In response to receiving the message from the network diagnosis device, the computing system 130 may initiate a network performance test of the network path 175 between the network diagnosis device 105 at the customer premises 115 and testing server 145 in the network(s) 140. The network performance test may comprise sending one or more test packets from one of the network diagnosis device 105 or the testing server 145 to the other of the network diagnosis device 105 or the testing server 145 along the network path 175, and the other of the network diagnosis device 105 or the testing server 145 capturing the one or more test packets.

The computing system 130 may analyze network performance data collected from the network performance test to identify any issues with network service provided to the CPE 110 assigned to the user and to isolate a source of any identified issues with the network service provided to the CPE 110, by analyzing the captured one or more test packets (a copy of which may be sent to the computing system via the cellular communications network(s), or alternatively via a different network path through the service provider network(s)) to determine whether at least one of packet loss, out-of-order packets, improper device configuration, reduced packet transmission speed, or firewall interference has occurred.

The computing system 130 may send results of the network performance test and information pertaining to any identified issues with the network service based on the analysis. The information pertaining to any identified issues with the network service may comprise at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

In another aspect, network diagnosis device 105 may send a message to computing system 130 over a network(s), the message indicating that the network diagnosis device 105 is communicatively coupled to CPE 110 at customer premises 115 associated with the user and that it is ready to begin diagnosis. In some embodiments, sending the message to the computing system over the network may comprise the network diagnosis device 105 sending the message to the computing system 130 over the network(s), in response to the network diagnosis device 105 being powered on and being communicatively coupled to the CPE 110 at the customer premises 115 associated with the user. In the case that the network diagnosis device 105 is able to establish a stable cellular communications connection with cellular communications network(s) 155, the network diagnosis device 105 may send the message to the computing system 130 via cellular communications network(s) 155 and via telecommunications relay systems 160a and 160b. In the case that the network diagnosis device 105 is not able to establish a stable cellular communications connection with cellular communications network(s) 155, the network diagnosis device 105 may send the message to the computing system 130 via the CPE 110 and the service provider network(s) 140.

In response to receiving the message from the network diagnosis device 105, the computing system 130 may initiate a network performance test of a network path between the network diagnosis device 105 at the customer premises 115 and the testing server 145 in the network(s) 140, the network path further including the CPE 110 and one or more intermediate network nodes 150 (in this case, nodes 150a and 150h, along the network path 175; or alternatively, any combination of nodes 150 along network path defined by one or more paths denoted by dashed line 180) between the CPE 110 and the testing server 145.

The computing system 130 may analyze network performance data collected from the network performance test to identify any performance issues with network service provided to the CPE 110 assigned to the user, and may send results of the network performance test and information pertaining to any identified performance issues with the network service provided to the CPE 110 based on the analysis.

According to some embodiments, initiating the network performance test may comprise: sending one or more test packets from a first device among a plurality of devices along the network path through a second device among the plurality of devices along the network path, wherein the plurality of devices comprises the network diagnosis device, the CPE, the testing server, and each of the one or more intermediate network nodes; and capturing, using the second device, the one or more test packets.

In some embodiments, sending the one or more test packets from the first device to the second device along the network path may comprise at least one of: sending one or more test packets from one of the network diagnosis device 105 or the testing server 145 to the other of the network diagnosis device 105 or the testing server 145 along the network path; sending one or more test packets from one of the network diagnosis device 105 or the CPE 110 to the other of the network diagnosis device 105 or the CPE 110 along the network path; sending one or more test packets from one of the CPE 110 or a first intermediate network node 150 (e.g., node 150a, 150c, or 150e, as shown in FIG. 1, or the like) among the one or more intermediate network nodes 150a-150h to the other of the CPE 110 or the first intermediate network node 150 (e.g., node 150a, 150c, or 150e, or the like) along the network path; sending one or more test packets from one of a second intermediate network node 150 (e.g., node 150a-150f, as shown in FIG. 1, or the like) among the one or more intermediate network nodes 150a-150h or a third intermediate network node 150 (e.g., node 150a-150h, as shown in FIG. 1, or the like) among the one or more intermediate network nodes 150a-150h to the other of the second intermediate network node (e.g., node 150a-150f, or the like) or the third intermediate network node along the network path (e.g., node 150a-150h, or the like); or sending one or more test packets from one of a fourth intermediate network node 150 (e.g., node 150g or 150h, as shown in FIG. 1, or the like) among the one or more intermediate network nodes 150a-150h or the testing server 145 to the other of the fourth intermediate network node (e.g., node 150g or 150h, or the like) or the testing server 145 along the network path; and/or the like. In some instances, the first and second intermediate network nodes may be the same network node. Alternatively, the first and second intermediate network nodes may be different intermediate network nodes. In some cases, the third and fourth intermediate network nodes may be the same network node. Alternatively, the third and fourth intermediate network nodes may be different intermediate network nodes.

According to some embodiments, the computing system analyzing the network performance data collected from the network performance test may comprise the computing system analyzing network performance data collected from the network performance test to identify any issues with network service provided to the CPE 110 assigned to the user and to isolate a source of any identified issues with the network service provided to the CPE 110, by analyzing the captured one or more test packets to determine whether at least one of one or more network performance issues has occurred. The one or more network performance issues may include, without limitation, one or more of packet loss, out-of-order packets, improper device configuration, reduced packet transmission speed, reduced throughput, or firewall interference, and/or the like. In some cases, the information pertaining to any identified issues with the network service may include, but is not limited to, at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like. In some instances, determining whether at least one of one or more network performance issues has occurred may comprise determining that there are no network performance issues and that the system and network are operating within acceptable (and/or expected) parameters.

In some embodiments, identifying any performance issues may comprise determining that packet loss has occurred, which may comprise: counting the one or more test packets that are sent to determine a first number of packets; counting the captured one or more test packets to determine a second number of packets; and comparing the first number of packets with the second number of packets to determine whether the second number of packets is less than the first number of packets. According to some embodiments, a copy of the captured one or more test packets may be sent to the computing system 130 via the cellular communications network(s) 155, or the like, or via a different network path via service provider network(s) 140, or the like).

Alternatively, or additionally, identifying any performance issues may comprise determining that out-of-order packets has occurred, which may comprise: determining a first order in which the one or more test packets are sent; determining a second order in which the captured one or more test packets are received; and comparing the first order with the second order to determine whether the second order is different from the first order. According to some embodiments, a copy of the information regarding the second order may be sent to the computing system 130 via the cellular communications network(s) 155, or the like, or via a different network path via service provider network(s) 140, or the like).

Alternatively, or additionally, identifying any performance issues may comprise determining that improper device configuration has occurred, which may comprise: comparing the captured one or more test packets with the one or more test packets that are sent to determine whether any of the plurality of devices along the network path has a network configuration or a device configuration that is not optimal for transmission of the one or more test packets compared with expected optimal packet transmission characteristics. According to some embodiments, a copy of the captured one or more test packets may be sent to the computing system 130 via the cellular communications network(s) 155, or the like, or via a different network path via service provider network(s) 140, or the like). In some cases, because the network nodes (whether edge or intermediate), the testing server, and the computing system are operated (or controlled) by the service provider, improper (or non-optimal) device configuration may be determined beforehand (i.e., before the network diagnosis device is communicatively coupled to the CPE at the customer premises associated with the user, in some cases, before the network diagnosis device is even shipped to the user at the customer premises), and at least one of device configuration and/or network configuration may be optimized for each of the network nodes (whether edge or intermediate) as well as for the testing server and/or the computing system.

Alternatively, or additionally, identifying any performance issues may comprise determining that reduced packet transmission speed has occurred, which may comprise: determining a first time at which the one or more test packets are sent; determining a second time at which the captured one or more test packets are received; counting the captured one or more test packets to determine a third number of packets; calculating a first average packet transmission speed based on the third number of packets and a difference between the second time and the first time; and comparing the first average packet transmission speed with an expected packet transmission speed to determine whether the first average packet transmission speed is less than the expected packet transmission speed by a first predetermined threshold amount. According to some embodiments, a copy of the second time may be sent to the computing system 130 via the cellular communications network(s) 155, or the like, or via a different network path via service provider network(s) 140, or the like).

Alternatively, or additionally, identifying any performance issues may comprise determining that reduced throughput has occurred, which may comprise: determining a first processing rate at which the one or more test packets that are sent are processed by the first device; determining a second processing rate at which the captured one or more test packets are processed by the second device; and comparing the first processing rate with the second processing rate to determine whether the second processing rate is different from the first processing rate by a second predetermined threshold amount. According to some embodiments, a copy of the information regarding the second processing rate may be sent to the computing system 130 via the cellular communications network(s) 155, or the like, or via a different network path via service provider network(s) 140, or the like). Alternatively, or additionally, actual processing rates of a device may be compared with expected processing rates of said device (with this process being repeated for each device).

Alternatively, or additionally, identifying any performance issues may comprise determining that firewall interference has occurred, which may comprise: counting header bytes of the one or more test packets that are sent to determine a first number of header bytes; counting header bytes of the captured one or more test packets to determine a second number of header bytes; and comparing the first number of header bytes with the second number of header bytes to determine whether the second number of header bytes is less than the first number of header bytes. According to some embodiments, a copy of the information regarding the second number of header bytes may be sent to the computing system 130 via the cellular communications network(s) 155, or the like, or via a different network path via service provider network(s) 140, or the like).

In some aspects, the network diagnosis device (which, in some cases, may include a program or device referred to herein as “PiPerf,” “network diagnosis device,” or “device,” or the like) may be configured to automate iPerf-type testing and analysis with communication to/from the device with a wireless connection (e.g., 3G, 4G, 4G LTE, or 5G, etc.). In this manner, the service provider can ship the network diagnosis device directly to the customer at the customer premises. Once the customer plugs the device into the customer's CPE (e.g., Internet or multiprotocol label switching (“MPLS”) connection, or the like) and powers it on, the device will “phone” home (i.e., initiate a call or otherwise send a message to computing system 130, or the like) and wait for the technician to initiate the performance test. Service Assurance technicians can navigate through a user-friendly menu to complete the iPerf-type testing. In some cases, the device may be plugged directly into the customer's CPE (e.g., router, or the like) to bypass any complex LAN environment, the customer's under-performing user device (e.g., laptop, desktop, etc.), or other outside influences, and/or the like, thus ensuring a quick and accurate result.

Further, field technicians in Enterprise Repair may be empowered to troubleshoot and resolve customer throughput issues quickly, accurately, and much more efficiently, and without the need to go through extensive training with the PiPerf interface or use. This will improve the customer's experience for this type of issue and will also positively impact field technicians by reducing the number of truck rolls. After the PiPerf test is finished, the technician will be presented with the summary of test results. In some cases, these test results may indicate to the technician as to whether the circuit (or network connection) is performing well, or if not performing well, The test results may also indicate to the technician where the problem may be located. In some embodiments, the PiPerf software may be used on one of 100 Mbps, 1 Gbps, or 10 Gbps hardware, but it must be used on hardware that has been properly benchmarked, in some cases, hardware that is owned and operated by the service provider. In some non-limiting embodiments, a 100 Mbps device may comprise a Raspberry Pi 3B+ that is combined with 4G hardware (e.g., Nimbelink Adapter, Modem, and SIM card, etc.) that are all housed inside a 3D-printed case or housing. In other non-limiting embodiments, a 1 Gbps device may include a Shuttle DH370 (or the like) with 4G hardware (e.g., Nimbelink Adapter, Modem, and SIM card, etc.) that is externally attached.

According to some embodiments, PiPerf may be a transmission control protocol (“TCP”) throughput testing tool that combines both software and hardware to more easily and more quickly test and analyze the performance of a customer's circuit. In some instances, TCP may be used to track the amount of data that is allowed to be sent at a given point, which is dictated by the host receiving the data, the host sending the data, and the conditions of the network. Three TCP windows may be used in a TCP connection: (i) Receive Window (“RWIN”); (ii) Send Window (“SWIN”); and (iii) Congestion Window (“CWIN”). Each window serves an important purpose for the flow of data between the TCP sender (or client) and TCP receiver (or server), where that data can flow in either direction: client to server; or server to client.

The RWIN dictates how much data a TCP receiver is willing to accept before sending an acknowledgement (“ACK”) back to the TCP sender. The receiver will advertise its RWIN to the sender and thus the sender knows it cannot send more than an RWIN's worth of data before receiving an ACK from receiver. The SWIN dictates how much data a TCP sender will be allowed send before it must receive an ACK from the TCP receiver. The CWIN is a variable that changes dynamically according to the conditions of the network. If data is lost or delivered out-of-order, the CWIN is typically reduced. The RWIN and SWIN are configurable values on the host, while the CWIN is dynamic and cannot be configured. To obtain the best possible performance out of TCP, the goal is to fill the TCP window whenever possible, in terms of bytes over time.

In some cases, PiPerf may use automation (e.g., using custom Python code, or the like) to perform TCP throughput testing (e.g., iPerf-type testing), packet capturing (e.g., tcpdump, or the like) and packet capture analysis (e.g., tcptrace and custom Python code, or the like). The advantage of PiPerf may include having multiple viewpoints (i.e., a device both in the service provider cloud and a device at the customer site), automation, analysis, baselined hardware, 4G connectivity and the custom “phone home” Python code, or the like.

Without PiPerf, a technician would have to manually run iPerf software and would have to try to interpret the results. The iPerf results would indicate to the technician whether or not the customer is achieving the correct (i.e., expected or subscribed to) speed. When the customer is not achieving the correct speed, the iPerf results do not indicate why, or where the problem is. Finding out the “why” requires packet capture analysis of the TCP iPerf test. There is a big learning curve when it comes to effectively using packet capture analysis for TCP throughput performance problems. This has historically meant that only highly specialized engineers were the ones who could troubleshoot these complex TCP throughput problems.

PiPerf solves this by providing the technician with a menu-based testing tool. Technicians no longer have to memorize or lookup the commands to perform TCP throughput tests. Technicians also no longer have to spend several hours sifting through hundreds of thousands of packets in a packet capture. PiPerf automates the setting up of packet capture on the remote device and the central server, and then runs the iPerf-type test and analyzes the results. The analysis provides something that iPerf and packet capture analysis do not provide on their own—namely, the analysis would show the reason for the poor speeds (e.g., packet loss, out-of-order packets, TCP windowing, etc.). Additionally, the analysis provides the number of packets sent and number of packets received between the two devices (remote device and central server). PiPerf may also be used to automate packet loss isolation using these packet counts.

Even with the proper knowledge on how to troubleshoot TCP throughput performance problems, testing is still a laborious task as technicians are repeating the same commands many times over. The time commitments to run TCP throughput testing and packet capture analysis are further extended when: (a) the engineer must manually walk the customer or field tech through what commands to type at the keyboard; (b) the engineer often does not have remote access the device at the customer site; (c) trying to set up remote access to the on-site device requires approval for administrator rights or opening up a port in a firewall—which approvals can take days or weeks (PiPerf solves for this by automatically phoning home); (d) the device at the customer site does not have the proper administrator rights to install the packet capture software; (e) the device at the customer site has not been properly benchmarked—which may require resorting to troubleshooting one's own troubleshooting tool, which wastes several hours if not days of troubleshooting; and/or (f) the user has to set-up route leaking for testing MPLS L3VPN circuits (PiPerf may be used to solve for this by automating route leaking configuration, or the like).

In some cases, performing a TCP-based throughput test requires a computer (e.g., laptop, desktop, server, etc) at the customer site. In some instances, trying to use a customer or field technician computer may create problems as previously mentioned (e.g., walking someone else through manual testing, remote access, administrator rights, updating firewall rules, hardware that has not been benchmarked).

PiPerf solves for these problems by benchmarking service provider-owned hardware ahead of time, which we can then be shipped to the customer on demand. Then, all the customer or field technician has to do is to plug in the power and Ethernet cables to the device. Once the cables are plugged in, the PiPerf device will attempt to phone home over 4G (using a reverse SSH tunnel with a GRE/BGP, or the like) provided there is a sufficient 4G signal. If there is no 4G signal, PiPerf will phone home over the circuit (using a reverse SSH tunnel). The BGP session provides us with failover capabilities in the event that there is no 4G connectivity. This phone home feature allows the custom Python code, which is stored on the central server, to have complete control over the testing.

These and other functions of the system 100 (and its components) are described in greater detail below with respect to FIGS. 2-4.

FIG. 2 is a schematic diagram illustrating various non-limiting examples 200 of transmission of messages and test packets during implementation of end-to-end network performance measurement, diagnosis, and tuning, in accordance with various embodiments.

With reference to the non-limiting embodiment of FIG. 2, system 200 may include, without limitation, a network diagnosis device 105, a customer premises equipment (“CPE”) 110, nodes 150a and 150h, a testing server 145, a computing system 130, service provider network(s) 140, and cellular communications network(s) 155, or the like. In some cases, network diagnosis device 105, CPE 110, nodes 150a and 150h, testing server 145, computing system 130, service provider network(s) 140, and cellular communications network(s) 155 of FIG. 2 may correspond to (or are otherwise similar, if not identical, to) the network diagnosis device 105, the CPE 110, any of the nodes 150a-150h, the testing server 145, the computing system 130, the service provider network(s) 140, and the cellular communications network(s) 155 of FIG. 1, respectively, and the descriptions of these components of system 100 are applicable to the corresponding components of system 200, respectively. Dashed lines 205a-205f in FIG. 2 correspond to network diagnosis device 105, CPE 110, node 150a, node 150h, testing server 145, and computing system 130, respectively.

In response to being powered on and being communicatively coupled to CPE 110, network diagnosis device 105 may send a message 210 to computing system 130 over a network, the message indicating that the network diagnosis device 105 is communicatively coupled to the CPE 110 and that it is ready to begin diagnosis. The network diagnosis device 105 is configured to communicate with the computing system 130 via a cellular communications channel via cellular communications network(s) 155 (including at least one of 3G, 4G, 4G LTE, or 5G network(s), or the like) and is further configured to communicate with the computing system 130 over the service provider network(s) 140 via the CPE 110 and via one of a SSH tunnel or a reverse SSH tunnel over a network path 215 (similar to network paths denoted by lines 175 and/or lines 180 in FIG. 1, or the like) that connects a plurality of devices including the network diagnosis device 105, the CPE 110, Node 150a, Node 150h, and testing server 145 (which is communicatively coupled to computing system 130). In the case that the network diagnosis device 105 is able to establish a stable cellular communications connection with cellular communications network(s) 155, the network diagnosis device 105 may wirelessly send the message (as denoted by lightning bolt symbols in FIG. 2) to the computing system 130 via cellular communications network(s) 155. In the case that the network diagnosis device 105 is not able to establish a stable cellular communications connection with cellular communications network(s) 155, the network diagnosis device 105 may send the message to the computing system 130 via the CPE 110 and the service provider network(s) 140 along network path 215.

After establishing a SSH or reverse SSH tunnel 220a between network 105 and testing server 145, the computing system 130 may send one or more test packets 225a from the testing server 145 to the network diagnosis device 105 via the SSH or reverse SSH tunnel 220a (in this case, along the network path 215 connecting in series the network diagnosis device 105, the CPE 110, node 150a, node 150h, and the testing server 145, or the like). The network diagnosis device 105 may receive or capture one or more test packets 225b. The computing system 130 may compare the one or more test packets 225a that are sent with the captured one or more test packets 225b (a copy of which may be sent to the computing system 130 via the cellular communications network(s) 155, or the like, or via a different network path via service provider network(s) 140, or the like).

Although not shown in FIG. 2, a SSH or reverse SSH tunnel may be used to wirelessly send the message 210 and/or the copies of captured test packets 225 (or information regarding captured test packets) from the network diagnosis device 105 and the computing system 130 over the cellular communications network(s) 155.

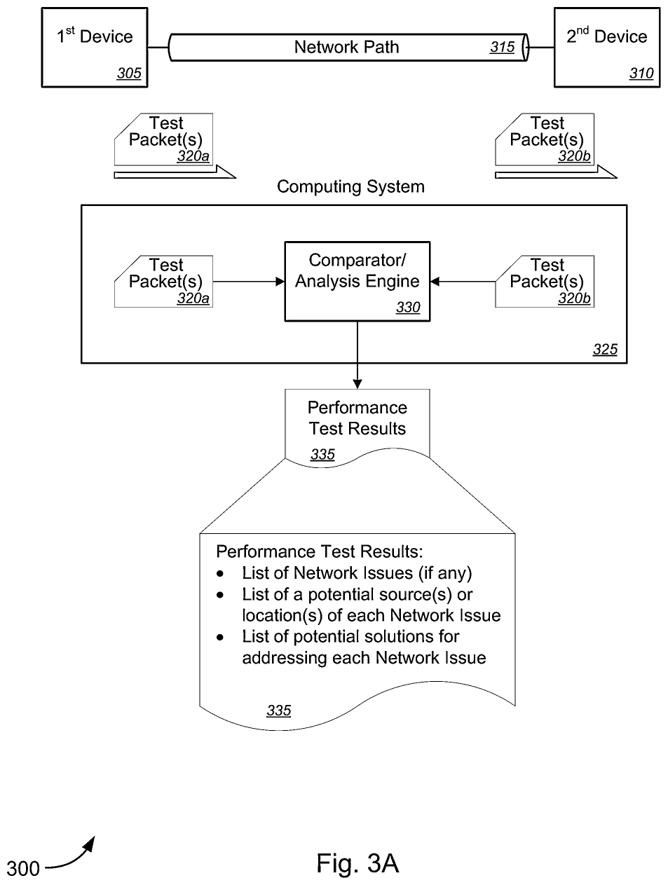

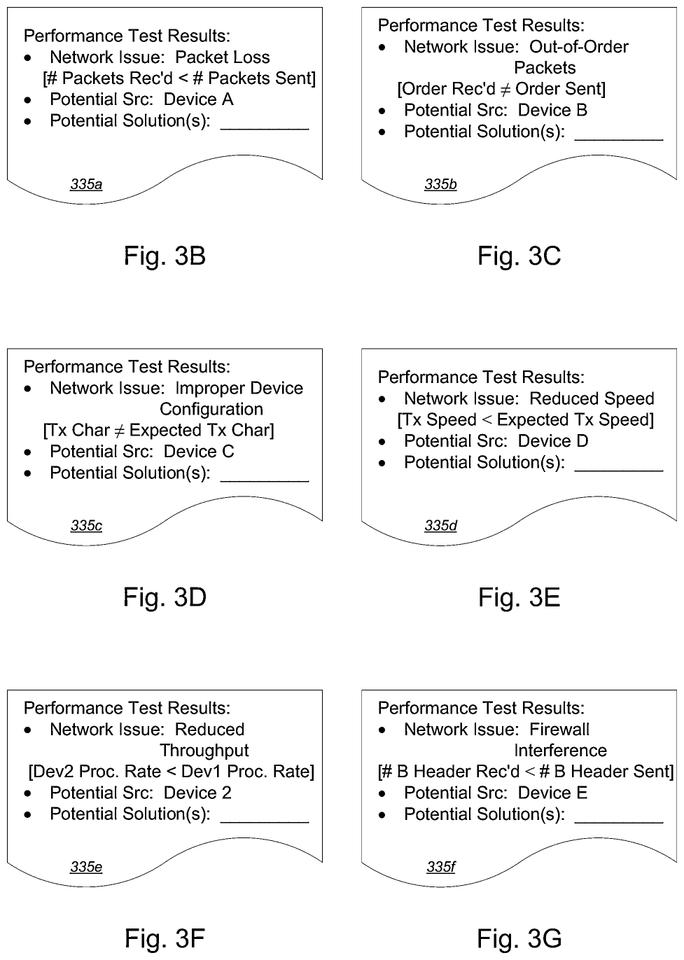

FIGS. 3A-3G (collectively, “FIG. 3”) are schematic diagrams illustrating a non-limiting example 300 of comparison of captured test packets with test packets that are sent to determine whether at least one of packet loss, out-of-order packets, improper device configuration, reduced packet transmission speed, or firewall interference has occurred during implementation of end-to-end network performance measurement, diagnosis, and tuning, in accordance with various embodiments.

Referring to the non-limiting embodiment of FIG. 3, system 300 may comprise a first device 305, a second device 310, and a network path 315 between the first device 305 and the second device 310. The first device 305 and the second device 310 are among a plurality of devices, which includes, without limitation, the network diagnosis device 105, the CPE 110, the testing server 145, and each of the one or more intermediate network nodes 150 of FIGS. 1 and/or 2, or the like, and the descriptions of these components of system 100 or 200 are applicable to the corresponding components of system 300, respectively.

The first device 305 may send one or more test packets 320a to the second device 310 via the network path 315. The second device 310 may capture one or more test packets 320b. Computing system 325 may comprise a comparator or analysis engine 330, which may be used to compare the captured one or more test packets 320b with the one or more test packets 320a that are sent by the first device 305 to produce performance test results 335. The computing system 325 may correspond to the computing system 130 of FIG. 1 or 2, or the like, and the descriptions of this component of system 100 or 200 are applicable to the corresponding component of system 300, respectively.

In some embodiments, as shown in the non-limiting example of FIG. 3A, the performance test results 335 may include, but are not limited to, at least one of a list of network issues (if any are present), a list of potential sources or locations for each network issue, and/or a list of potential solutions for addressing each network issue, and/or the like.

In the non-limiting example of FIG. 3B, the performance test results 335a may include, but are not limited to, at least one of packet loss as a network issue (which may be identified by determining that the number of test packets that are received 320b is less than the number of test packets that are sent 320a), Device A as a potential source of the network issue, and/or one or more potential solutions for addressing the network issue.

In the non-limiting example of FIG. 3C, the performance test results 335b may include, but are not limited to, at least one of out-of-order packets as a network issue (which may be identified by determining that the order of test packets that are received 320b is different from the order of test packets that are sent 320a), Device B as a potential source of the network issue, and/or one or more potential solutions for addressing the network issue.

In the non-limiting example of FIG. 3D, the performance test results 335c may include, but are not limited to, at least one of improper device configuration as a network issue (which may be identified by determining that the (actual or measured) packet transmission characteristics are different from the expected packet transmission characteristics), Device C as a potential source of the network issue, and/or one or more potential solutions for addressing the network issue.

In the non-limiting example of FIG. 3E, the performance test results 335d may include, but are not limited to, at least one of reduced packet transmission speed as a network issue (which may be identified by determining that the (actual or measured) packet transmission speed is different from the expected packet transmission speed), Device D as a potential source of the network issue, and/or one or more potential solutions for addressing the network issue.

In the non-limiting example of FIG. 3F, the performance test results 335e may include, but are not limited to, at least one of reduced throughput as a network issue (which may be identified by determining that the processing rate of the second device 310 is less than the processing rate of the first device 305), Device 2 as a potential source of the network issue, and/or one or more potential solutions for addressing the network issue. Alternatively, or additionally, actual processing rates of a device may be compared with expected processing rates of said device (with this process being repeated for each device) as part of the determination that the network issue includes reduced throughput.

In the non-limiting example of FIG. 3G, the performance test results 335f may include, but are not limited to, at least one of firewall interference as a network issue (which may be identified by determining that the number of header bytes in the test packets that are received 320b is less than the number of header bytes in the test packets that are sent 320a), Device E as a potential source of the network issue, and/or one or more potential solutions for addressing the network issue.

In some instances, although not shown in FIG. 3, the performance test results 335 may include a determination that there are no network performance issues and that the system and network are operating within acceptable (and/or expected) parameters.

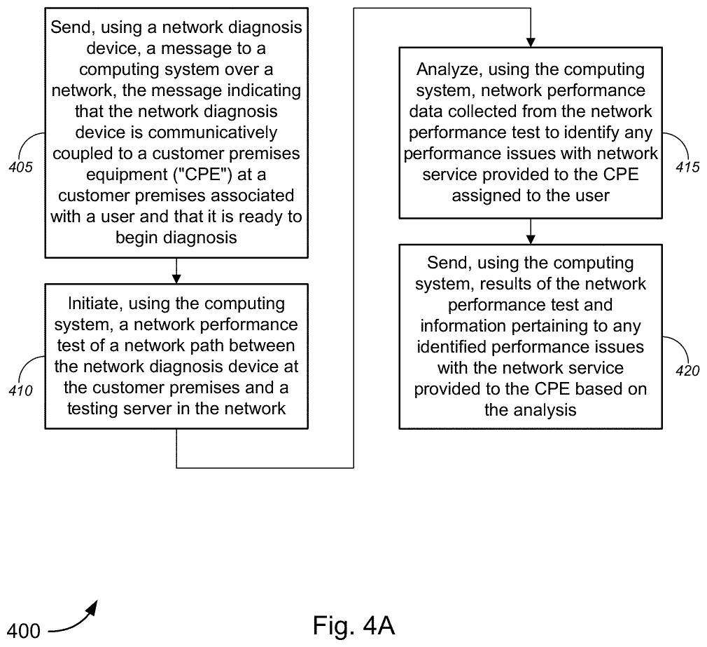

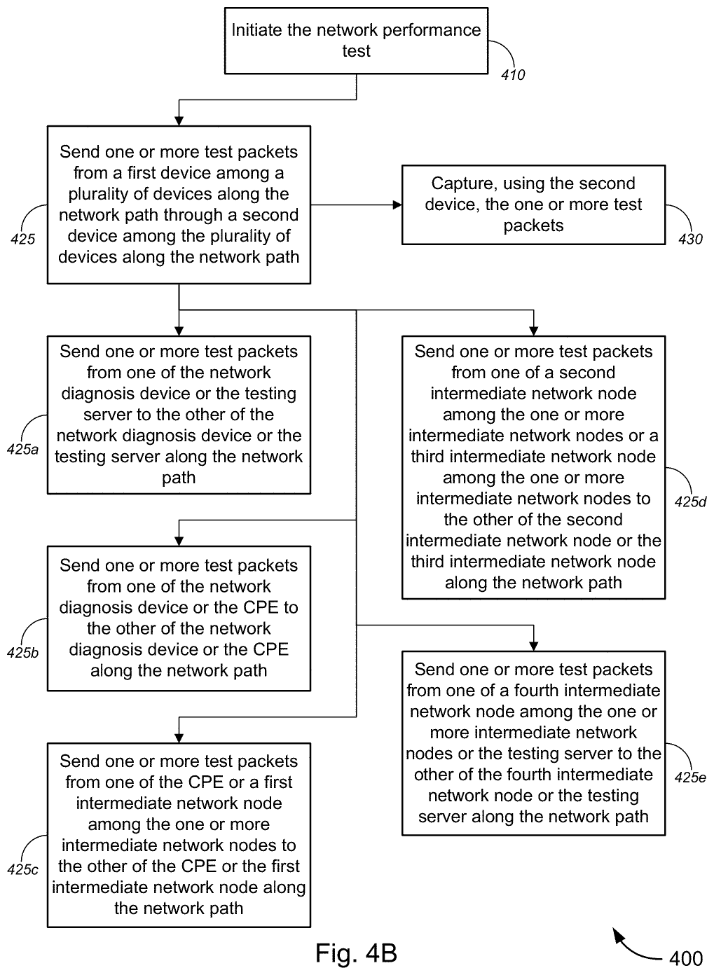

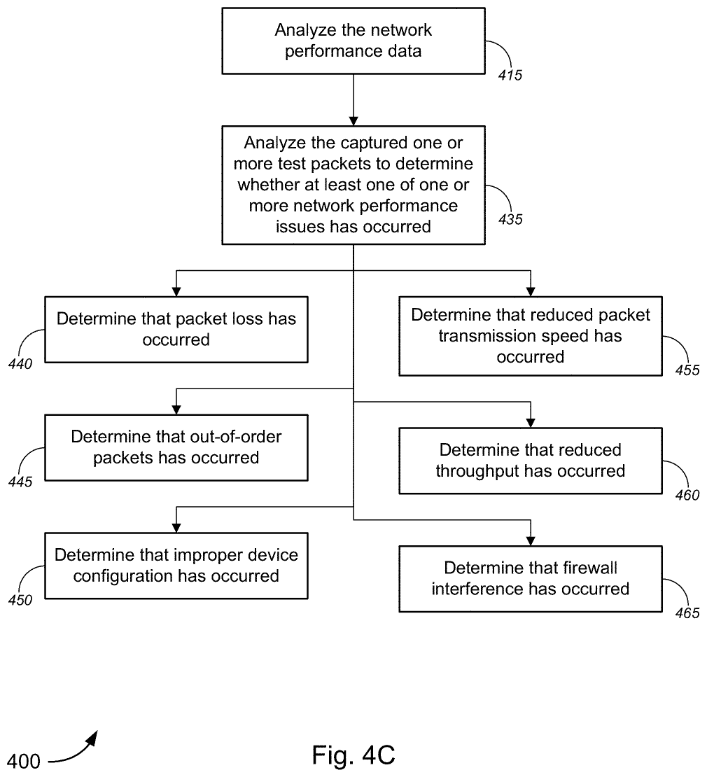

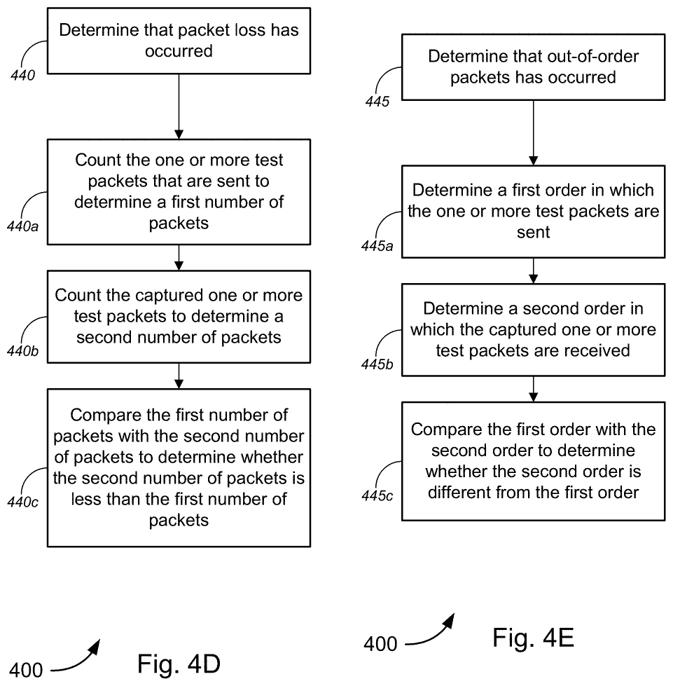

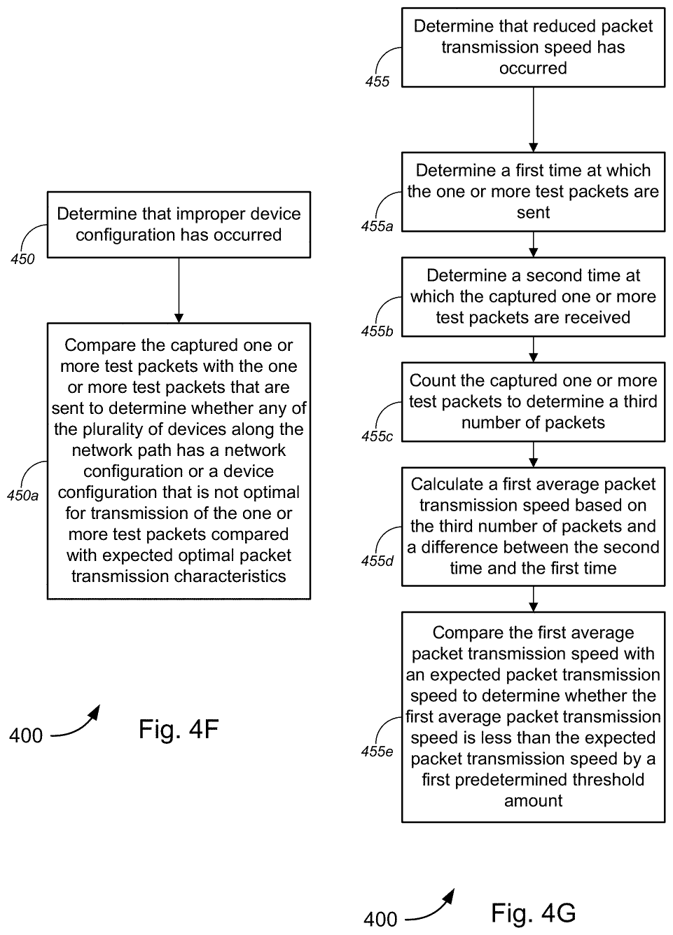

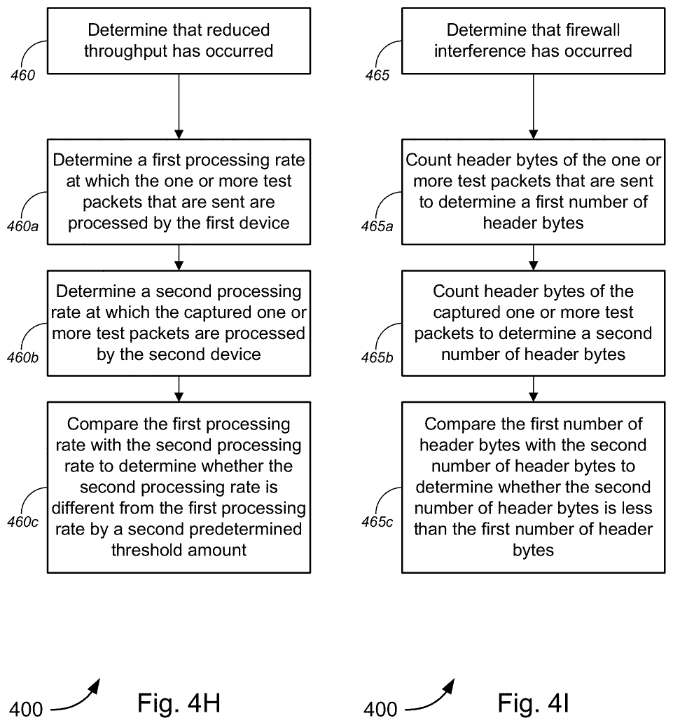

FIGS. 4A-4I (collectively, “FIG. 4”) are flow diagrams illustrating a method 400 for implementing end-to-end network performance measurement, diagnosis, and tuning, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIG. 4 (e.g., by executing instructions embodied on a computer readable medium), the systems, examples, or embodiments 100, 200, and 300 of FIGS. 1, 2, and 3 can each also operate according to other modes of operation and/or perform other suitable procedures.

In the non-limiting embodiment of FIG. 4A, method 400, at block 405, may comprise sending, using a network diagnosis device, a message to a computing system over a network, the message indicating that the network diagnosis device is communicatively coupled to a customer premises equipment (“CPE”) at a customer premises associated with a user and that it is ready to begin diagnosis.

In some embodiments, the network diagnosis device may be a plug-and-play device that is configured to communicate with the computing system via a cellular communications channel and that is further configured to communicate with the computing system over the network via the CPE. In some cases, the cellular communications channel may include, without limitation, at least one of a third generation (“3G”) broadband cellular network communications channel, a fourth generation (“4G”) broadband cellular network communications channel, a 4G long term evolution (“LTE”) broadband cellular network communications channel, or a fifth generation (“5G”) broadband cellular network communications channel, and/or the like. In some instances, the network diagnosis device may be configured to communicate with the computing system over the network via the CPE, using one of a secure shell (“SSH”) tunnel or a reverse SSH tunnel. Herein, a SSH tunnel may refer to a secure channel over a network (typically, over an unsecure network) that is established when a SSH connection is initiated from a local computer to a remote computer, while a reverse SSH tunnel may refer to a similar secure channel over a network (typically, over an unsecure network) that is established when a SSH connection is initiated from the remote computer to the local computer. In some cases, a reverse SSH tunnel may be used if the remote computer is difficult to reach (e.g., due to tight firewall rules, complex network address translation rules, and/or the like).

According to some embodiments, the network diagnosis device may include, but is not limited to, at least one of a Raspberry Pi-based network diagnosis device, a network interface controller (“NIC”), or a high-performance computing device, and/or the like. In some instances, the computing system may include, without limitation, at least one of a server computer, the testing server, a cloud-based computing system, or a distributed computing system, and/or the like.

In some embodiments, sending the message to the computing system over the network (at block 405) may comprise sending, using the network diagnosis device, the message to the computing system over the network, in response to the network diagnosis device being powered on and being communicatively coupled to the CPE at the customer premises associated with the user.

At block 410, method 400 may comprise initiating, using the computing system, a network performance test of a network path between the network diagnosis device at the customer premises and a testing server in the network, in some cases, in response to receiving the message from the network diagnosis device. In some instances, the network path may further include the CPE and one or more intermediate network nodes between the CPE and the testing server, or the like.

Method 400 may further comprise, at block 415, analyzing, using the computing system, network performance data collected from the network performance test to identify any performance issues with network service provided to the CPE assigned to the user.

Method 400 may further comprise sending, using the computing system, results of the network performance test and information pertaining to any identified performance issues with the network service provided to the CPE based on the analysis (block 420). In some embodiments, the information pertaining to any identified issues with the network service may include, without limitation, at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

With reference to the non-limiting embodiment of FIG. 4B, initiating the network performance test (at block 410) may comprise: sending one or more test packets from a first device among a plurality of devices along the network path through a second device among the plurality of devices along the network path (block 425); and capturing, using the second device, the one or more test packets (block 430). In some cases, the plurality of devices may include, but is not limited to, the network diagnosis device, the CPE, the testing server, and each of the one or more intermediate network nodes, and/or the like.

According to some embodiments, sending the one or more test packets from the first device to the second device along the network path (at block 425) may comprise at least one of: sending one or more test packets from one of the network diagnosis device or the testing server to the other of the network diagnosis device or the testing server along the network path (block 425a); sending one or more test packets from one of the network diagnosis device or the CPE to the other of the network diagnosis device or the CPE along the network path (block 425b); sending one or more test packets from one of the CPE or a first intermediate network node among the one or more intermediate network nodes to the other of the CPE or the first intermediate network node along the network path (block 425c); sending one or more test packets from one of a second intermediate network node among the one or more intermediate network nodes or a third intermediate network node among the one or more intermediate network nodes to the other of the second intermediate network node or the third intermediate network node along the network path (block 425d); or sending one or more test packets from one of a fourth intermediate network node among the one or more intermediate network nodes or the testing server to the other of the fourth intermediate network node or the testing server along the network path (block 425e). In some instances, the first and second intermediate network nodes may be the same network node. Alternatively, the first and second intermediate network nodes may be different intermediate network nodes. In some cases, the third and fourth intermediate network nodes may be the same network node. Alternatively, the third and fourth intermediate network nodes may be different intermediate network nodes.

Turning to the non-limiting example of FIG. 4C, analyzing, using the computing system, the network performance data collected from the network performance test (at block 415) may comprise analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of one or more network performance issues has occurred (block 435). In some embodiments, identifying any performance issues (at block 435) may comprise at least one of: determining that packet loss has occurred (block 440); determining that out-of-order packets has occurred (block 445); determining that improper device configuration has occurred (block 450); determining that reduced packet transmission speed has occurred (block 455); determining that reduced throughput has occurred (block 460); determining that firewall interference has occurred (block 465); and/or the like. In some instances, although not shown in FIG. 4C, determining whether at least one of one or more network performance issues has occurred (at block 435) may comprise determining that there are no network performance issues and that the system and network are operating within acceptable (and/or expected) parameters.

With reference to FIG. 4D, determining that packet loss has occurred (at block 440) may comprise: counting the one or more test packets that are sent to determine a first number of packets (block 440a); counting the captured one or more test packets to determine a second number of packets (block 440b); and comparing the first number of packets with the second number of packets to determine whether the second number of packets is less than the first number of packets (block 440c).

Turning to FIG. 4E, determining that out-of-order packets has occurred (at block 445) may comprise: determining a first order in which the one or more test packets are sent (block 445a); determining a second order in which the captured one or more test packets are received (block 445b); and comparing the first order with the second order to determine whether the second order is different from the first order (block 445c).

Referring to FIG. 4F, determining that improper device configuration has occurred (at block 450) may comprise: comparing the captured one or more test packets with the one or more test packets that are sent to determine whether any of the plurality of devices along the network path has a network configuration or a device configuration that is not optimal for transmission of the one or more test packets compared with expected optimal packet transmission characteristics (block 450a). In some cases, because the network nodes (whether edge or intermediate), the testing server, and the computing system are operated (or controlled) by the service provider, improper (or non-optimal) device configuration may be determined beforehand (i.e., before the network diagnosis device is communicatively coupled to the CPE at the customer premises associated with the user, in some cases, before the network diagnosis device is even shipped to the user at the customer premises), and at least one of device configuration and/or network configuration may be optimized for each of the network nodes (whether edge or intermediate) as well as for the testing server and/or the computing system.

With reference to FIG. 4G, determining that reduced packet transmission speed has occurred (at block 455) may comprise: determining a first time at which the one or more test packets are sent (block 455a); determining a second time at which the captured one or more test packets are received (block 455b); counting the captured one or more test packets to determine a third number of packets (block 455c); calculating a first average packet transmission speed based on the third number of packets and a difference between the second time and the first time (block 455d); and comparing the first average packet transmission speed with an expected packet transmission speed (e.g., based on service level agreement (“SLA”) with the user or based on the subscribed service, or the like) to determine whether the first average packet transmission speed is less than the expected packet transmission speed by a first predetermined threshold amount (block 455e).

Turning to FIG. 4H, determining that reduced throughput has occurred (at block 460) may comprise: determining a first processing rate at which the one or more test packets that are sent are processed by the first device (block 460a); determining a second processing rate at which the captured one or more test packets are processed by the second device (block 460b); and comparing the first processing rate with the second processing rate to determine whether the second processing rate is different from the first processing rate by a second predetermined threshold amount (block 460c). Alternatively, or additionally, actual processing rates of a device may be compared with expected processing rates of said device (with this process being repeated for each device).

Referring to FIG. 4I, determining that firewall interference has occurred (at block 465) may comprise: counting header bytes of the one or more test packets that are sent to determine a first number of header bytes (block 465a); counting header bytes of the captured one or more test packets to determine a second number of header bytes (block 465b); and comparing the first number of header bytes with the second number of header bytes to determine whether the second number of header bytes is less than the first number of header bytes (block 465c).

Exemplary System and Hardware Implementation

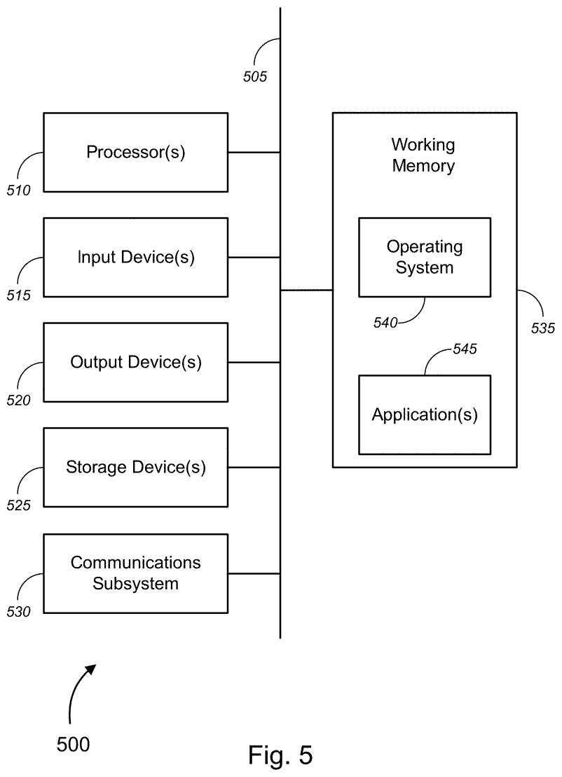

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., network diagnosis device 105, customer premises equipment (“CPE”) 110, computing systems 130 and 325, testing server 145, nodes 150a-150h, devices 305 and 310, and user devices 120 and 165, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., network diagnosis device 105, CPE 110, computing systems 130 and 325, testing server 145, nodes 150a-150h, devices 305 and 310, and user devices 120 and 165, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

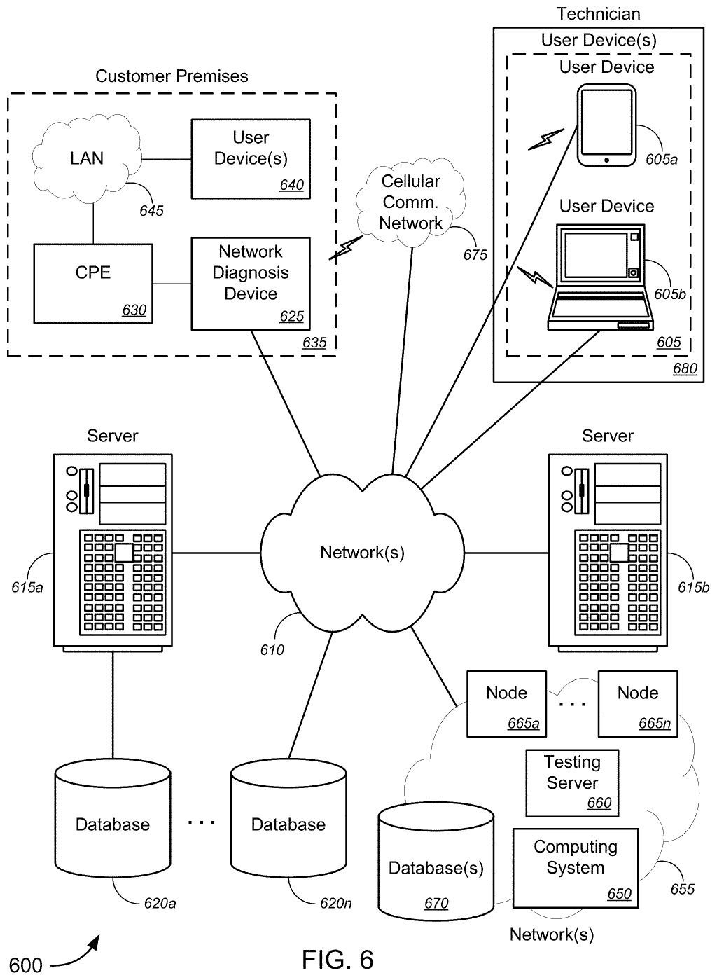

As noted above, a set of embodiments comprises methods and systems for implementing network performance measurement, and, more particularly, to methods, systems, and apparatuses for implementing end-to-end network performance measurement, diagnosis, and tuning. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 and 655 (similar to network(s) 140 of FIGS. 1 and 2, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet. The cellular communications network(s) 675 can include, but is not limited to, a third generation (“3G”) broadband cellular network, a fourth generation (“4G”) broadband cellular network, a 4G long term evolution (“LTE”) broadband cellular network, or a fifth generation (“5G”) broadband cellular network, and/or the like.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybas™, IBM™, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing network performance measurement, and, more particularly, to methods, systems, and apparatuses for implementing end-to-end network performance measurement, diagnosis, and tuning, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a network diagnosis device 625 (similar to network diagnosis device 105 of FIGS. 1 and 2 and/or device 305 or 310 of FIG. 3, or the like) and a customer premises equipment (“CPE”) 630 (similar to CPE 110 of FIGS. 1 and 2, or the like), both disposed or located at a customer premises 635 associated with a user (similar to customer premises 115 associated with a user, as shown in FIG. 1, or the like). In some cases, the CPE 630 may communicatively couple with one or more user devices 640 (similar to user devices 120 of FIG. 1 and/or device 305 or 310 of FIG. 3, or the like) within customer premises 635 via local area network (“LAN”) 645 (similar to LAN 125 of FIG. 1, or the like).

In some embodiments, system 600 may further comprise a computing system 650 (similar to computing systems 130 and 325 of FIGS. 1-3, or the like) disposed within service provider network(s) 655 (similar to service provider network(s) 140 of FIG. 1, or the like). System 600 may further comprise a testing server 660 (similar to testing server 145 of FIGS. 1 and 2 and/or device 305 or 310 of FIG. 3, or the like), network nodes or nodes 665a-665n nodes (collectively, “nodes 665” or the like; similar to network nodes or nodes 150a-150h of FIGS. 1 and 2 and/or devices 305 and 310 of FIG. 3, or the like), and database(s) 670 (similar to database(s) 135 of FIG. 1, or the like), each of which may also be disposed within service provider network(s) 655. In some cases, user device(s) 605 (including user device 605a and/or 605b, or the like; similar to user device 165 of FIG. 1, or the like) may be associated with a technician 680, who may be an employee or a contractor (or sub-contractor) of the service provider.

In operation, the service provider may send the network diagnosis device 625 to the user at the customer premises 635 for the user to plug into the CPE 630. In response to the network diagnosis device 625 being powered on and being communicatively coupled to CPE 630 at customer premises 635 associated with the user, network diagnosis device 625 may send a message to computing system 650 over a network, the message indicating that the network diagnosis device is communicatively coupled to the CPE and that it is ready to begin diagnosis. The network diagnosis device 625 is configured to communicate with the computing system 650 via a cellular communications channel via cellular communications network(s) 675 (including at least one of 3G, 4G, 4G LTE, or 5G network(s), or the like) and is further configured to communicate with the computing system 650 over the service provider network(s) 655 (and/or 610) via the CPE 630 and via one of a SSH tunnel or a reverse SSH tunnel over a network path that connects a plurality of devices including the network diagnosis device 625, the CPE 630, testing server 660 (which is communicatively coupled to computing system 650), and any intermediate nodes among nodes 665a-665n.

In response to receiving the message from the network diagnosis device, the computing system 650 may initiate a network performance test of the network path between the network diagnosis device 625 at the customer premises 635 and testing server 660 in the network(s) 655 (and/or 610). The network performance test may comprise sending one or more test packets from one of the network diagnosis device 625 or the testing server 660 to the other of the network diagnosis device 625 or the testing server 660 along the network path, and the other of the network diagnosis device 625 or the testing server 660 capturing the one or more test packets.

The computing system 650 may analyze network performance data collected from the network performance test to identify any issues with network service provided to the CPE 630 assigned to the user and to isolate a source of any identified issues with the network service provided to the CPE 630, by analyzing the captured one or more test packets (a copy of which may be sent to the computing system via the cellular communications network(s), or alternatively via a different network path through the service provider network(s)) to determine whether at least one of packet loss, out-of-order packets, improper device configuration, reduced packet transmission speed, or firewall interference has occurred.

The computing system 650 may send results of the network performance test and information pertaining to any identified issues with the network service based on the analysis. The information pertaining to any identified issues with the network service may comprise at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like.

In another aspect, network diagnosis device 625 may send a message to computing system 650 over a network(s), the message indicating that the network diagnosis device 625 is communicatively coupled to CPE 630 at customer premises 635 associated with the user and that it is ready to begin diagnosis. In some embodiments, sending the message to the computing system over the network may comprise the network diagnosis device 625 sending the message to the computing system 650 over the network(s), in response to the network diagnosis device 625 being powered on and being communicatively coupled to the CPE 630 at the customer premises 635 associated with the user. In the case that the network diagnosis device 625 is able to establish a stable cellular communications connection with cellular communications network(s) 675, the network diagnosis device 625 may send the message to the computing system 650 via cellular communications network(s) 675. In the case that the network diagnosis device 625 is not able to establish a stable cellular communications connection with cellular communications network(s) 675, the network diagnosis device 625 may send the message to the computing system 650 via the CPE 630 and the service provider network(s) 655 (and/or 610).

In response to receiving the message from the network diagnosis device 625, the computing system 650 may initiate a network performance test of a network path between the network diagnosis device 625 at the customer premises 635 and the testing server 660 in the network(s) 655 (and/or 610), the network path further including the CPE 630 and one or more intermediate network nodes 665 (in this case, at least one of nodes 665a-665n, along the network path) between the CPE 630 and the testing server 660.

The computing system 650 may analyze network performance data collected from the network performance test to identify any performance issues with network service provided to the CPE 630 assigned to the user, and may send results of the network performance test and information pertaining to any identified performance issues with the network service provided to the CPE 630 based on the analysis.

According to some embodiments, initiating the network performance test may comprise: sending one or more test packets from a first device among a plurality of devices along the network path through a second device among the plurality of devices along the network path, wherein the plurality of devices comprises the network diagnosis device, the CPE, the testing server, and each of the one or more intermediate network nodes; and capturing, using the second device, the one or more test packets.

In some embodiments, sending the one or more test packets from the first device to the second device along the network path may comprise at least one of: sending one or more test packets from one of the network diagnosis device 625 or the testing server 660 to the other of the network diagnosis device 625 or the testing server 660 along the network path; sending one or more test packets from one of the network diagnosis device 625 or the CPE 630 to the other of the network diagnosis device 625 or the CPE 630 along the network path; sending one or more test packets from one of the CPE 630 or a first intermediate network node (e.g., node 665a, or the like) among the one or more intermediate network nodes 665a-665n to the other of the CPE 630 or the first intermediate network node along the network path; sending one or more test packets from one of a second intermediate network node (e.g., node 665b, or the like) among the one or more intermediate network nodes 665a-665n or a third intermediate network node (e.g., node 665c, or the like) among the one or more intermediate network nodes 665a-665n to the other of the second intermediate network node or the third intermediate network node along the network path; or sending one or more test packets from one of a fourth intermediate network node (e.g., node 665d, or the like) among the one or more intermediate network nodes 665a-665n or the testing server 660 to the other of the fourth intermediate network node or the testing server 660 along the network path; and/or the like. In some instances, the first and second intermediate network nodes may be the same network node. Alternatively, the first and second intermediate network nodes may be different intermediate network nodes. In some cases, the third and fourth intermediate network nodes may be the same network node. Alternatively, the third and fourth intermediate network nodes may be different intermediate network nodes.

According to some embodiments, the computing system analyzing the network performance data collected from the network performance test may comprise the computing system analyzing network performance data collected from the network performance test to identify any issues with network service provided to the CPE 630 assigned to the user and to isolate a source of any identified issues with the network service provided to the CPE 630, by analyzing the captured one or more test packets to determine whether at least one of one or more network performance issues has occurred. The one or more network performance issues may include, without limitation, one or more of packet loss, out-of-order packets, improper device configuration, reduced packet transmission speed, reduced throughput, or firewall interference, and/or the like. In some cases, the information pertaining to any identified issues with the network service may include, but is not limited to, at least one of: information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues; and/or the like. In some instances, determining whether at least one of one or more network performance issues has occurred may comprise determining that there are no network performance issues and that the system and network are operating within acceptable (and/or expected) parameters.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
in response to being powered on and being communicatively coupled to a customer premises equipment (“CPE”) at a customer premises associated with a user, sending, using a network diagnosis device, a message to a computing system over a network, the message indicating that the network diagnosis device is communicatively coupled to the CPE and that it is ready to begin diagnosis, wherein the network diagnosis device is a plug-and-play device that is configured to communicate with the computing system via a cellular communications channel and that is further configured to communicate with the computing system over the network via the CPE and via one of a secure shell (“SSH”) tunnel or a reverse SSH tunnel;
in response to receiving the message from the network diagnosis device, initiating, using the computing system, a network performance test of a network path between the network diagnosis device at the customer premises and a testing server in the network, the network path further including the CPE and one or more intermediate network nodes between the CPE and the testing server, wherein the network performance test comprises sending one or more test packets from one of the network diagnosis device or the testing server to the other of the network diagnosis device or the testing server along the network path and capturing, using the other of the network diagnosis device or the testing server, the one or more test packets;
analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of packet loss, out-of-order packets, improper device configuration, reduced packet transmission speed, or firewall interference has occurred; and
sending, using the computing system, results of the network performance test and information pertaining to any identified issues with the network service based on the analysis, wherein the information pertaining to any identified issues with the network service comprises at least one of information regarding whether at least one of packet loss, out-of-order packets, improper device configuration, reduced packet transmission speed, reduced throughput, or firewall interference has occurred; information regarding a potential source or location of the identified issues; or information regarding potential solutions for addressing the identified issues.

2. A method, comprising:
sending, using a network diagnosis device, a message to a computing system over a network, the message indicating that the network diagnosis device is communicatively coupled to a customer premises equipment (“CPE”) at a customer premises associated with a user and that it is ready to begin diagnosis;
in response to receiving the message from the network diagnosis device, initiating, using the computing system, a network performance test of a network path between the network diagnosis device at the customer premises and a testing server in the network, the network path further including the CPE and one or more intermediate network nodes between the CPE and the testing server;
analyzing, using the computing system, network performance data collected from the network performance test to identify any performance issues with network service provided to the CPE assigned to the user; and
sending, using the computing system, results of the network performance test and information pertaining to any identified performance issues with the network service provided to the CPE based on the analysis.

3. The method of claim 2, wherein the network diagnosis device is a plug-and-play device that is configured to communicate with the computing system via a cellular communications channel and that is further configured to communicate with the computing system over the network via the CPE.

4. The method of claim 3, wherein the cellular communications channel comprises at least one of a third generation (“3G”) broadband cellular network communications channel, a fourth generation (“4G”) broadband cellular network communications channel, a 4G long term evolution (“LTE”) broadband cellular network communications channel, or a fifth generation (“5G”) broadband cellular network communications channel.

5. The method of claim 3, wherein the network diagnosis device is configured to communicate with the computing system over the network via the CPE, using one of a secure shell (“SSH”) tunnel or a reverse SSH tunnel.

6. The method of claim 2, wherein the network diagnosis device comprises at least one of a Raspberry Pi-based network diagnosis device, a network interface controller (“NIC”), or a high-performance computing device.

7. The method of claim 2, wherein the computing system comprises at least one of a server computer, the testing server, a cloud-based computing system, or a distributed computing system.

8. The method of claim 2, wherein sending, using the network diagnosis device, the message to the computing system over the network comprises sending, using the network diagnosis device, the message to the computing system over the network, in response to the network diagnosis device being powered on and being communicatively coupled to the CPE at the customer premises associated with the user.

9. The method of claim 2, wherein initiating the network performance test comprises:
sending one or more test packets from a first device among a plurality of devices along the network path through a second device among the plurality of devices along the network path, wherein the plurality of devices comprises the network diagnosis device, the CPE, the testing server, and each of the one or more intermediate network nodes; and
capturing, using the second device, the one or more test packets.

10. The method of claim 9, wherein sending the one or more test packets from the first device to the second device along the network path comprises at least one of:
sending one or more test packets from one of the network diagnosis device or the testing server to the other of the network diagnosis device or the testing server along the network path;
sending one or more test packets from one of the network diagnosis device or the CPE to the other of the network diagnosis device or the CPE along the network path;
sending one or more test packets from one of the CPE or a first intermediate network node among the one or more intermediate network nodes to the other of the CPE or the first intermediate network node along the network path;
sending one or more test packets from one of a second intermediate network node among the one or more intermediate network nodes or a third intermediate network node among the one or more intermediate network nodes to the other of the second intermediate network node or the third intermediate network node along the network path; or
sending one or more test packets from one of a fourth intermediate network node among the one or more intermediate network nodes or the testing server to the other of the fourth intermediate network node or the testing server along the network path.

11. The method of claim 9, wherein analyzing, using the computing system, the network performance data collected from the network performance test comprises analyzing, using the computing system, network performance data collected from the network performance test to identify any issues with network service provided to the CPE assigned to the user and to isolate a source of any identified issues with the network service provided to the CPE, by analyzing the captured one or more test packets to determine whether at least one of one or more network performance issues has occurred.

12. The method of claim 11, wherein the one or more network performance issues comprise one or more of packet loss, out-of-order packets, improper device configuration, reduced packet transmission speed, reduced throughput, or firewall interference.

13. The method of claim 12, wherein the information pertaining to any identified issues with the network service comprises at least one of:
information regarding whether at least one of packet loss, out-of-order packets, improper device configuration, reduced packet transmission speed, reduced throughput, or firewall interference has occurred;
information regarding a potential source or location of the identified issues; or
information regarding potential solutions for addressing the identified issues.

14. The method of claim 12, wherein identifying any performance issues comprises determining that packet loss has occurred, wherein determining that packet loss has occurred comprises:
counting the one or more test packets that are sent to determine a first number of packets;
counting the captured one or more test packets to determine a second number of packets; and
comparing the first number of packets with the second number of packets to determine whether the second number of packets is less than the first number of packets.

15. The method of claim 12, wherein identifying any performance issues comprises determining that out-of-order packets has occurred, wherein determining that out-of-order packets has occurred comprises:
determining a first order in which the one or more test packets are sent;
determining a second order in which the captured one or more test packets are received; and
comparing the first order with the second order to determine whether the second order is different from the first order.

16. The method of claim 12, wherein identifying any performance issues comprises determining that improper device configuration has occurred, wherein determining that improper device configuration has occurred comprises:
comparing the captured one or more test packets with the one or more test packets that are sent to determine whether any of the plurality of devices along the network path has a network configuration or a device configuration that is not optimal for transmission of the one or more test packets compared with expected optimal packet transmission characteristics.

17. The method of claim 12, wherein identifying any performance issues comprises determining that reduced packet transmission speed has occurred, wherein determining that reduced packet transmission speed has occurred comprises:
determining a first time at which the one or more test packets are sent;
determining a second time at which the captured one or more test packets are received;
counting the captured one or more test packets to determine a third number of packets;
calculating a first average packet transmission speed based on the third number of packets and a difference between the second time and the first time; and
comparing the first average packet transmission speed with an expected packet transmission speed to determine whether the first average packet transmission speed is less than the expected packet transmission speed by a first predetermined threshold amount.

18. The method of claim 12, wherein identifying any performance issues comprises determining that reduced throughput has occurred, wherein determining that reduced throughput has occurred comprises:
determining a first processing rate at which the one or more test packets that are sent are processed by the first device;
determining a second processing rate at which the captured one or more test packets are processed by the second device; and
comparing the first processing rate with the second processing rate to determine whether the second processing rate is different from the first processing rate by a second predetermined threshold amount.

19. The method of claim 12, wherein identifying any performance issues comprises determining that firewall interference has occurred, wherein determining that firewall interference has occurred comprises:
counting header bytes of the one or more test packets that are sent to determine a first number of header bytes;
counting header bytes of the captured one or more test packets to determine a second number of header bytes; and
comparing the first number of header bytes with the second number of header bytes to determine whether the second number of header bytes is less than the first number of header bytes.

20. A system, comprising:
a network diagnosis device, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the network diagnosis device to:
send a message to a computing system over a network, the message indicating that the network diagnosis device is communicatively coupled to a customer premises equipment (“CPE”) at a customer premises associated with a user and that it is ready to begin diagnosis;
a computing system, comprising:
at least one second processor; and
a second non-transitory computer readable medium communicatively coupled to the at least one second processor, the second non-transitory computer readable medium having stored thereon computer software comprising a second set of instructions that, when executed by the at least one second processor, causes the computing system to:
in response to receiving the message from the network diagnosis device, initiate a network performance test of a network path between the network diagnosis device at the customer premises and a testing server in the network, the network path further including the CPE and one or more intermediate network nodes between the CPE and the testing server;
analyze network performance data collected from the network performance test to identify any performance issues with network service provided to the CPE assigned to the user; and
send results of the network performance test and information pertaining to any identified performance issues with the network service provided to the CPE based on the analysis.
